(19) United States
(12) Patent Application Publication
(10) Pub. No.: US 2003/0143955 A1
(43) Pub. Date: Jul. 31, 2003

(54) Communication system monitor

(76) Inventor: Daniel D. Van Winkle, San Rafael, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/059,625

(22) Filed: Jan. 29, 2002

(51) Int. Cl. H04B 17/00

(52) U.S. Cl. 455/67.1; 455/67.3

(57) ABSTRACT

A monitor for a communication system injects a shaped pulse into the communication system at a first point. The shaped pulse has a short time duration to enable the integrity of the communication system to be monitored in a short amount of time. The shaped pulse also has a narrow frequency spectrum to avoid interference with live signals present in the communication system. The monitor includes a source generating a carrier signal having an adjustable frequency, a modulator receiving the carrier signal and modulating the carrier signal to provide the shaped pulse. Alternatively, the monitor includes a signal source directly providing the shaped pulse. A receiver within the monitor detects the shaped pulse at one or more second points in the communication system. The shaped pulse is below live signals within the communication system by a predesignated threshold at a predetermined frequency offset from the frequency of the carrier signal.

### BACKGROUND OF THE INVENTION

In the past, cable networks were primarily used to distribute multiple channels of analog television signals. The integrity of such cable networks was monitored by stimulating a head end of the cable network with test pulses while measuring the amplitude of the test pulses at other points in the cable network remote from the head end. These amplitude measurements indicated the operating characteristics of amplifiers, transmission paths, switches, and other elements of the cable network.

Typically, the test pulses included a carrier signal modulated by a short-duration pulse train to form short-duration test pulses. These short-duration test pulses enabled the integrity of the cable network to be monitored in a short amount of time by stepping the frequency of the carrier signal over the operating frequency range, or bandwidth, of the cable network while a receiver performed the amplitude measurements on the short-duration test pulses. To minimize interference on the analog television signals distributed by the cable network, the carrier signals of the short-duration test pulses were positioned between the channels of analog television signals. Although the short-duration test pulses had inherently broad frequency spectra that overlapped the analog television signals, the analog television signals had enough immunity to interference to enable the short-duration test pulse to be used for monitoring these cable networks.

Modern cable networks support high-speed internet communications, interactive video applications, and digital transmissions in a variety of digital signal formats that exploit the frequency bandwidth of the cable networks. However, digital signals, such as 256 QAM (quadrature amplitude modulation) signals, within the cable networks are susceptible to interference caused by the short-duration test pulses that were sufficient for monitoring the cable network in the past. The frequency spectra of the short-duration test pulses overlap with the digital signals, increasing Bit Error Rates and otherwise impairing the performance of the modern cable networks. As a result, these short-duration test pulses, which provide short monitoring times, are not well-suited for monitoring modern cable networks in the presence of digital signals and other live signals that are sensitive to interference.

One known technique used to monitor modern cable networks uses test pulses that have long duration. These long-duration test pulses have frequency spectra that are narrowly focused about a carrier signal, which reduces interference with the live signals in the cable network. However, use of these long-duration test pulses results in substantial increases in the amount of time it takes to monitor the cable network, since monitoring the cable network involves dwelling at each frequency step of the carrier signal for at least as long as the time duration of the long-duration test pulses.

Accordingly, there is a need for a monitor for a cable network that has the benefits of the narrowly focused spectrum as provided by the long-duration test pulses, while maintaining the benefit of short monitoring times as provided by the short-duration test pulses. This need is met by a communication system monitor constructed according to the embodiments of the present invention.

### BRIEF DESCRIPTION OF THE DRAWINGS

FIGS. 1A-1B show the prior art short-duration test pulses used for monitoring cable networks.

FIGS. 2A-2B show the prior art long-duration test pulses used for monitoring cable networks.

FIGS. 3A-3B show a shaped pulse provided by a communication system monitor constructed according to the embodiments of the present invention.

FIG. 4 shows a communication system monitor constructed according to a first embodiment of the present invention.

FIG. 5 shows a communication system monitor constructed according to a second embodiment of the present invention.

FIG. 6 shows a communication system monitoring method constructed according to a third embodiment of the present invention.

### DETAILED DESCRIPTION OF THE EMBODIMENTS

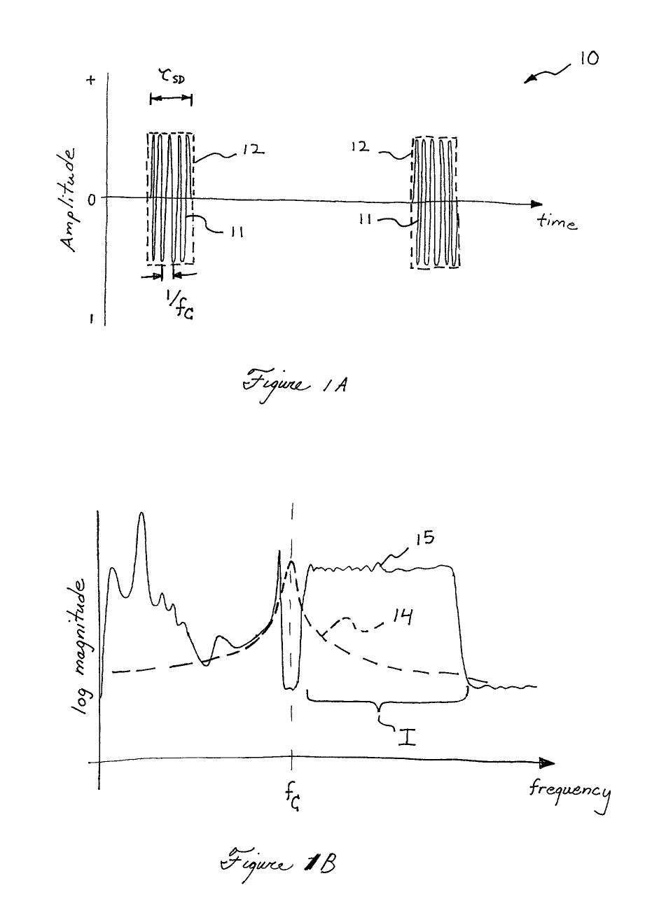

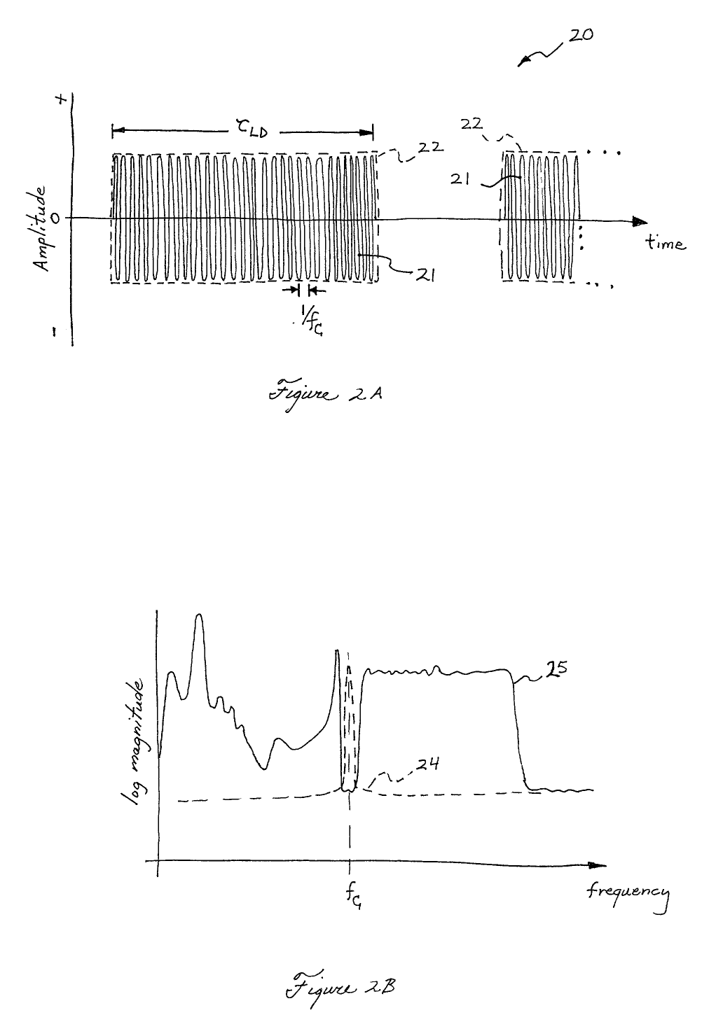

FIG. 1A shows an example of the prior art short-duration test pulse 10 used for monitoring cable networks. The short-duration test pulse 10 includes a carrier signal 11 that is modulated by a time-domain pulse train 12. The short-duration test pulse 10 is injected into a cable network (not shown) at one point, such as a head end, while the amplitude of the short-duration test pulse 10 is measured at other points of the cable network that are remote from the head end. The amplitude measurements indicate the operating characteristics of amplifiers, transmission paths, switches, and other elements of the cable network. The amplitude measurements are performed by a receiver as the frequency f_{C} of the carrier signal 11 is stepped over the operating frequency range of the cable network. Since monitoring the cable network includes dwelling at each frequency step of the carrier signal 11 for only as long as the time duration T_{SD} of the short-duration test pulse 10, monitoring the cable network using the short-duration test pulse 10 takes a short time.

The short-duration test pulse 10 has a corresponding frequency spectrum 14 that is shown in FIG. 1B. The frequency spectrum 14 of the short-duration test pulse 10 is so broad that the frequency spectrum 14 overlaps with live signals 15 present in the cable network. This overlap forms an interference region I that impairs the performance of the cable network, especially when the live signals 15 are digital signals or other signals that are sensitive to interference.

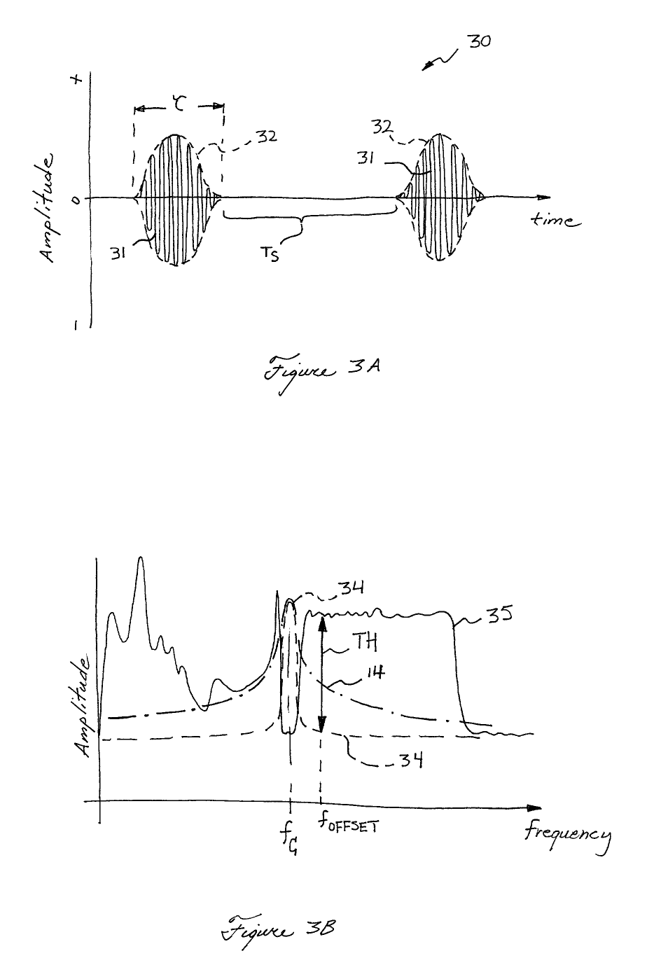

FIG. 2A shows an example of the prior art long-duration test pulse 20 used for monitoring cable networks. This long-duration test pulse 20 also has a carrier signal 21 of frequency f_{C} that is modulated by a time domain pulse train 22. However, this long-duration test pulse 20 has a corresponding frequency spectrum 24 (shown in FIG. 2B) that is narrowly focused about the frequency f_{C} of the carrier signal 21. The narrowly-focused frequency spectrum 24 has minimal overlap with live signals 25 within the cable network, thereby minimizing interference of the long-duration test pulse 20 with the live signals 25. While the narrowly-focused frequency spectrum 24 of the long-duration test pulse 20 is not broad enough to overlap with the live signals 25 and impair the performance of the cable network, the long-duration test pulse 20 increases the time it takes to monitor the cable network. As an example, a typical long-duration test pulse 20 of this type has a time duration τ_{LD} of 5-10 milliseconds in order to provide a frequency spectrum 24 that is sufficiently narrow to avoid interference with the live signals 25. Monitoring the cable network includes dwelling at each step of the frequency f_{C} of the carrier signal 21 for at least as long as the time duration τ_{LD} of the long-duration test pulse 20, while the amplitude of the long-duration test pulse 20 is measured by a receiver (not shown). Because monitoring the cable network typically includes making these amplitude measurements at hundreds of frequencies, it may take an unacceptably long amount of time to monitor the cable network.

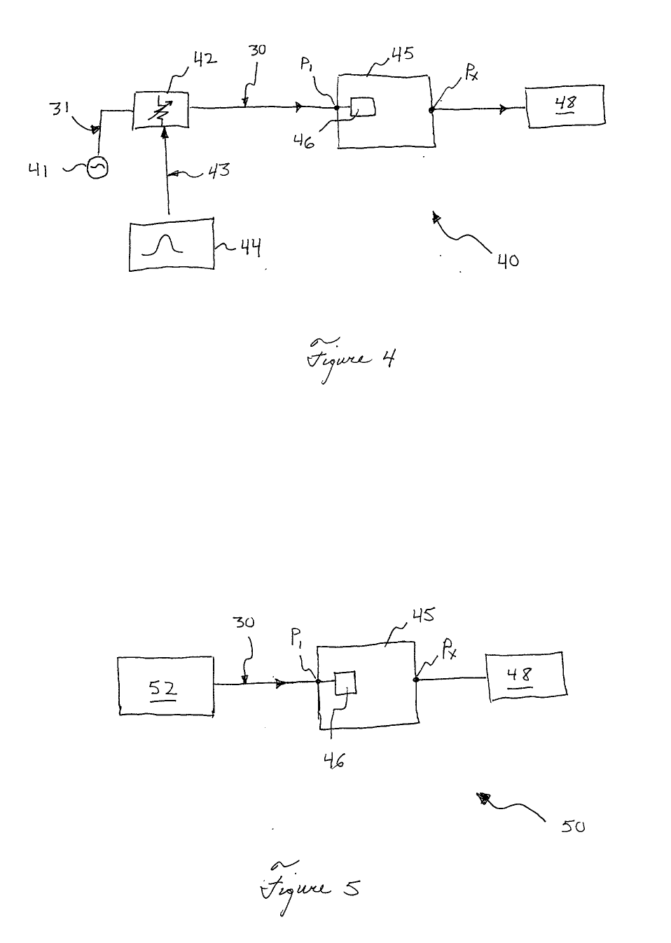

FIG. 3A shows a shaped pulse 30 provided by monitors 40, 50 constructed according to the embodiments of the present invention. The monitors 40, 50, shown in FIG. 4 and FIG. 5, respectively, are suitable for monitoring the integrity of cable networks and other type of communication systems 45—even in the presence of live signals within the communication systems 45. The shaped pulse 30 includes a carrier signal 31 at a frequency f_{C} that has an envelope 32 with a truncated SinX/X, or SINC, shape. The truncated SINC shape, in this example, extends to the first zero crossing on each side of the main lobe of a SINC function. The truncated SINC shape of the envelope 32 of the carrier signal 31 has a short time duration τ and also provides a narrow frequency spectrum 34 as shown in FIG. 3B. The short time duration τ of the shaped pulse 30 results in short monitoring times for the communication systems 45 within which the monitors 40, 50 are employed. The narrow frequency spectrum 34 of the shaped pulse 30 prevents interference with the live signals 35 in the communication system 45 when the shaped pulse 30 is injected into the communication system 45 by the monitors 40, 50. Interference with the live signals 35 in the communication system 45 decreases as a threshold TH by which the frequency spectrum 34 of the shaped pulse 30 is below the live signals 35 increases. The threshold TH is designated at a predetermined frequency offset f_{OFFSET} from the frequency f_{C} of the carrier signal 31. The threshold TH is sufficiently large so that at the predetermined frequency offset f_{OFFSET}, the frequency spectrum 34 of the shaped pulse 30 with the time duration τ, is below the frequency spectrum 14 of the short-duration pulse 10 when the time duration τ_{LD} of the short-duration pulse 10 is equivalent to the time duration τ of the shaped pulse 30.

FIG. 4 shows the monitor 40 for a communication system 45, constructed according to the first embodiment of the present invention. The monitor 40 is used to verify operating characteristics of amplifiers, filters, switches, transmission paths, and other elements of the communication system 45. The monitor 40 includes a source 41 that provides the carrier signal 31 of the shaped pulse 30. Typically, the source 41 is adjustable so that the frequency f_{C} of the carrier signal 31 can be stepped to a variety of predesignated frequencies within the operating frequency range of the communication system 45. Tuneable oscillators, signal synthesizers, signal generators, or tracking generators are some examples of the sources 41 that are suitable for providing the carrier signal 31.

A modulator 42, driven by a control signal 43, receives the carrier signal 31 and shapes the envelope 32 of the carrier signal 31 to produce the shaped pulse 30. The control signal 43 is provided by a waveform generator 44. In this example, the modulator 42 is an amplitude modulator having high dynamic range and the waveform generator 44 is an AGILENT TECHNOLOGIES, INC. model 33120A Arbitrary Waveform Generator. The waveform generator 44 is alternatively a programmable digital-to-analog converter cascaded with a filter and having suitable support circuitry (not shown) to generate the control signal 43 that drives the modulator 42 to shape the envelope 32 of the carrier signal 31 to form the shaped pulse 30. While the source 41 and the modulator 42 are shown as separate elements in FIG. 4, the source 41 and the modulator 42 are alternatively integrated within an AGILENT TECHNOLOGIES, INC. model 83732 Synthesized Signal Generator, or within another similar instrument.

FIG. 5 shows the monitor 50 for a communication system 45, constructed according to a second embodiment of the present invention. In this embodiment, the shaped pulse 30, including the carrier signal 31 with the envelope 32, is generated directly from a signal source 52, such as the model 33120A Arbitrary Waveform Generator. The signal source 52 is alternatively a high-speed programmable digital-to-analog converter with a cascaded filter and suitable support circuitry (not shown).

The shaped pulse 30 is injected into the communication system 45 at a first point P₁ via a coupler 46. The coupler 46 is typically an access point in a cable head end or an access point in another node of the communication system 45. Alternatively, the coupler 46 is a coaxial structure, microstrip structure, stripline structure, waveguide structure or other type of structure suitable for coupling the shaped pulse 30 into the communication system 45. In order to verify the operating characteristics of the communication system 45 without interrupting use of the communication system 45, the shaped pulse 30 is typically injected into the communication system 45 while the live signals 35 are present in the communication system 45.

A receiver 48 detects the shaped pulse 30 at one or more points P_{X} in the communication system 45 that are remote from the first point P1. The receiver 48 is typically synchronized with the frequency f_{C} of the carrier signal 31 and has the capability of measuring the amplitude of the shaped pulse 30 as the frequency f_{C} of the carrier signal 31 is stepped over the operating frequency range of the communication system 45, so that the operating characteristics of the communication system 45 are monitored.

Envelopes 32 for the shaped pulse 30 that are different from the truncated SINC shape are alternatively established according to the threshold TH by which the frequency spectrum 34 of the shaped pulse 30 is designated to be below the live signals 35 and according to an acceptable time duration τ of the shaped pulse 30. The threshold TH is designated by a maximum acceptable amount of interference with the live signals 35, by a maximum acceptable degradation in image quality when the live signals 35 represent images, by Bit Error Rates, or by other suitable performance measures for the communication system 45 being monitored. The acceptable time duration τ of the shaped pulse 30 is typically established to be less than the settling time of the signal source 52 and the receiver 48 of the monitor 50, or the source 41 and the receiver 48 of the monitor 40. In this example, a transition period T_{S} of 1 millisecond imposed between the envelopes 32 of the shaped pulse 30 accommodates the settling time. A time duration τ for the shaped pulse 30 not exceeding ten percent of the transition period T_{S} assures that the time duration τ of the shaped pulse 30 is short enough so that the time it takes to monitor the communication system 45 is dominated by the imposed transition period T_{S}.

Once the threshold TH is designated, curve fitting, mathematical synthesis or empirical designations are used to establish frequency spectra 34 that meet or exceed the designated threshold TH. An inverse Fourier Transform on these established frequency spectra 34 provides corresponding envelopes 32 for the shaped pulse 30. The envelopes 32 that correspond to the established frequency spectra 34 and that also have sufficiently short time durations τ are suitable for use in the monitors 40, 50. For the shaped pulse 30 shown in the example of FIGS. 3A-3B, the threshold TH is designated to be 35 dB at an offset of 1 MHz from the frequency f_{C} of the carrier signal 31, and the envelope 32 has a time duration τ of 6 microseconds. This threshold TH results in an acceptable Bit Error Rate for the communication system 45, and the time duration τ results in a short monitoring time for the communication system 45.

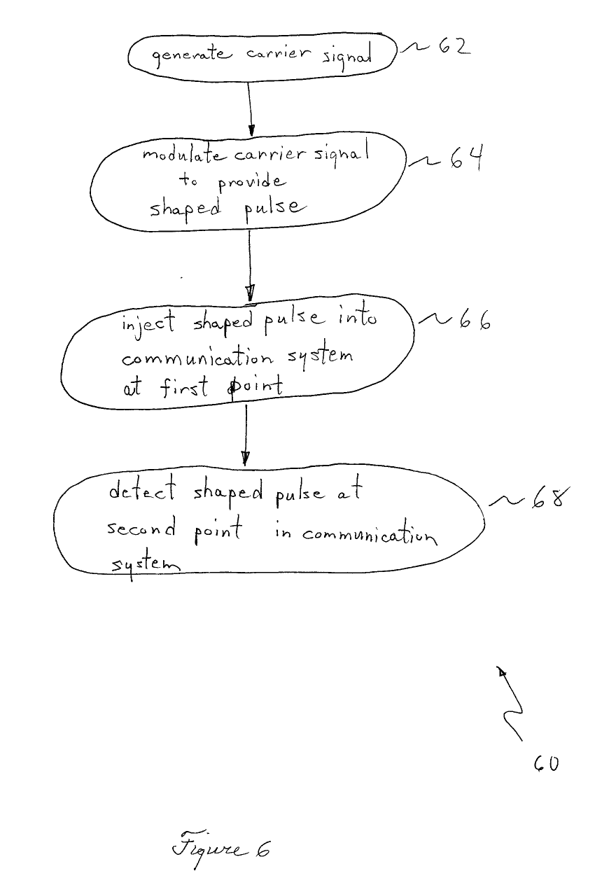

FIG. 6 shows a method 60 for monitoring a communication system 45, constructed according to a third embodiment of the present invention. In step 62, the carrier signal 31, adjustable to at least one predesignated frequency, is generated. The carrier signal 31 is modulated according to a control signal 43 (step 64) to provide the shaped pulse 30 that is injected into the communication system 45 at the first point P₁ (step 66), in the presence of one or more live signals 35 within the communication system 45. The shaped pulse 30 is detected at at least one second point P_{X} in the communication system 45, remote from the first point P₁ (step 68).

While the embodiments of the present invention have been illustrated in detail, it should be apparent that modifications and adaptations to these embodiments may occur to one skilled in the art without departing from the scope of the present invention as set forth in the following claims.

What is claimed is:

1. A monitor for a communication system, comprising:
a source generating a carrier signal adjustable to at least one predesignated frequency;
a modulator receiving the carrier signal and modulating the carrier signal according to a control signal to provide a shaped pulse;
a coupler, injecting the shaped pulse into the communication system at a first point, in the presence of at least one live signal within the communication system; and
a receiver, detecting the shaped pulse at at least one second point in the communication system, wherein the shaped pulse is below the at least one live signal by at least a predesignated threshold at a predesignated offset from each of the at least one predesignated frequency of the carrier signal, and wherein the shaped pulse has a time duration that is less than a settling time of the source and the receiver.

2. The monitor of claim 1 wherein the shaped pulse has an envelope that is a truncated SINC shape.

3. The monitor of claim 1 wherein the shaped pulse includes a transition period that accommodates the settling time of the source and the receiver, the time duration of the shaped pulse being less than ten percent of the transition period.

4. The monitor of claim 2 wherein the shaped pulse includes a transition period that accommodates the settling time of the source and the receiver, the time duration of the shaped pulse being less than ten percent of the transition period.

5. The monitor of claim 1 wherein detecting the shaped pulse includes measuring an amplitude of the shaped pulse at the at least one second point with the carrier signal adjusted to multiple ones of the at least one predesignated frequencies.

6. The monitor of claim 2 wherein detecting the shaped pulse includes measuring an amplitude of the shaped pulse at the at least one second point with the carrier signal adjusted to multiple ones of the at least one predesignated frequencies.

7. The monitor of claim 3 wherein detecting the shaped pulse includes measuring an amplitude of the shaped pulse at the at least one second point with the carrier signal adjusted to multiple ones of the at least one predesignated frequencies.

8. A monitor for a communication system, comprising:
a signal source generating a shaped pulse including a carrier signal adjustable to at least one predesignated frequency;
a coupler, injecting the shaped pulse into the communication system at a first point, in the presence of at least one live signal within the communication system; and
a receiver, detecting the shaped pulse at at least one second point in the communication system, wherein the shaped pulse is below the at least one live signal by at least a predesignated threshold at a predesignated offset from each of the at least one predesignated frequency of the carrier signal, and wherein the shaped pulse has a time duration that is less than a settling time of the signal source and the receiver.

9. The monitor of claim 8 wherein the shaped pulse has an envelope that is a truncated SINC shape.

10. The monitor of claim 8 wherein the shaped pulse includes a transition period that accommodates the settling time of the source and the receiver, the time duration of the shaped pulse being less than ten percent of the transition period.

11. The monitor of claim 9 wherein the shaped pulse includes a transition period that accommodates the settling time of the source and the receiver, the time duration of the shaped pulse being less than ten percent of the transition period.

12. The monitor of claim 8 wherein detecting the shaped pulse includes measuring an amplitude of the shaped pulse at the at least one second point with the carrier signal adjusted to multiple ones of the at least one predesignated frequencies.

13. The monitor of claim 9 wherein detecting the shaped pulse includes measuring an amplitude of the shaped pulse at the at least one second point with the carrier signal adjusted to multiple ones of the at least one predesignated frequencies.

14. The monitor of claim 10 wherein detecting the shaped pulse includes measuring an amplitude of the shaped pulse at the at least one second point with the carrier signal adjusted to multiple ones of the at least one predesignated frequencies.

15. A monitoring method for a communication system, comprising:
generating a carrier signal adjustable to at least one predesignated frequency;
modulating the carrier signal according to a control signal to provide a shaped pulse;
injecting the shaped pulse into the communication system at a first point, in the presence of at least one live signal within the communication system; and
detecting the shaped pulse at at least one second point in the communication system, wherein the shaped pulse is below the at least one live signal by at least a predesignated threshold at a predesignated offset from each of the at least one predesignated frequency of the carrier signal, and wherein the shaped pulse has a time duration that is less than a pre-established settling time.

16. The monitoring method of claim 15 wherein the shaped pulse has an envelope that is a truncated SINC shape.

17. The monitoring method of claim 15 wherein the shaped pulse includes a transition period that accommodates the pre-established settling time, the time duration of the shaped pulse being less than ten percent of the transition period.

18. The monitoring method of claim 16 wherein the shaped pulse includes a transition period that accommodates the pre-established settling time, the time duration of the shaped pulse being less than ten percent of the transition period.

19. The monitoring method of claim 15 wherein detecting the shaped pulse includes measuring an amplitude of the shaped pulse at the at least one second point with the carrier signal adjusted to multiple ones of the at least one predesignated frequencies.

20. The monitoring method of claim 16 wherein detecting the shaped pulse includes measuring an amplitude of the shaped pulse at the at least one second point with the carrier signal adjusted to multiple ones of the at least one predesignated frequencies.
